(19) United States
(12) Patent Application Publication
(10) Pub. No.: US 2024/0399387 A1
(43) Pub. Date: Dec. 5, 2024

(54) APPARATUS, SYSTEMS AND METHODS FOR USE IN FERROUS PARTICLE REMOVAL FROM A FLUID

(71) Applicant: ROMAR INTERNATIONAL LIMITED, Ellon Aberdeenshire (GB)

(72) Inventors: Martin McKenzie, Ellon Aberdeenshire (GB); Mark Lateu, Ellon Aberdeenshire (GB); Malcolm Mackenzie, Ellon Aberdeenshire (GB)

(21) Appl. No.: 18/695,451

(22) PCT Filed: Sep. 28, 2022
(86) PCT No.: PCT/GB2022/052460

§ 371 Date: Mar. 26, 2024

(30) Foreign Application Priority Data
Sep. 28, 2021 (GB) 2113861.5

(51) Int. Cl. B03C 1/28; C02F 1/48; C02F 103/10; E21B 21/06

(52) U.S. Cl. CPC B03C 1/28; C02F 1/481; B03C 2201/18; C02F 2103/10; C02F 2201/007; E21B 21/065

(57) ABSTRACT

The invention provides a modular frame for mounting at least one magnet apparatus in a fluid receptacle, a kit of parts for forming the modular frame, a system for removing ferrous particles from a fluid receptacle, and methods of use. The modular frame comprises first and second engagement members for engaging the frame with a wall of the fluid receptacle, and at least one coupling member for coupling the magnet apparatus to the frame. The magnet apparatus is mountable in the fluid receptacle to attract and remove ferrous or magnetically attractable particles from a fluid volume in the fluid receptacle. The first and second engagement members are respectively removably connected to the at least one coupling member. The modular frame may be assembled from a kit of standardised components to fit a particular fluid receptacle, and may be disassembled or reconfigured according to requirements.

The present invention relates to apparatus, systems and methods for use in the removal of ferrous or magnetically attractable particles from a fluid. In particular, the present invention relates to a frame for supporting ferrous or magnetically attractable particle removal tools for removing ferrous or magnetically attractable particles from a fluid. The invention has particular application in the oil and gas industry in relation to the removal of ferrous or magnetically attractable swarf from a liquid or slurry.

### Background to the Invention

In the oil and gas exploration and production industry, it is common to cut, mill, grind or drill through metal components. During such processes, fluid (commonly known as cutting, drilling or milling fluid) is used to lubricate and cool the cutting surfaces. This fluid is also often used to transfer the metal material removed by the cutting, milling, grinding or drilling process (known as swarf, also often referred to as cuttings) away from the cutting area to avoid clogging or damage to the tool. It is common practice to process and re-use this fluid. The processing step typically aims to remove the bulk of the metal material from the fluid before it is re-used or otherwise disposed of.

A known way of removing the metal material from contaminated fluid is to treat the fluid, such as drilling mud, in a fluid vessel, ditch or channel, using magnetic fields to separate the bulk of the metal material from the fluid before it is re-used.

Magnetic removal equipment can be heavy and bulky meaning that, following its delivery and installation on-site (typically an offshore oil and gas facility) its location and configuration tends to remain fixed. This lack of flexibility means that where there are multiple locations or possible locations for processing, the transport, delivery and installation of magnetic removal equipment to each of these locations is required, which is costly, time-consuming, and uses up a lot of space. Because of these difficulties, if one or more of the processing locations is only in use intermittently, the magnetic removal equipment is nonetheless tied to this location.

Where magnetic removal equipment is provided for retrofitting to an existing part of an oil and gas facility, it is typically necessary to produce a bespoke equipment, or to customise the equipment (or its components) in some way, to ensure that its shape and dimensions are appropriate for its desired setting. The equipment might also need to be customised to provide the required degree of ferrous particle removal. Where the magnetic removal capabilities of the equipment need to be changed in the future (for example, due to an increase in swarf production), it might be necessary to remove the equipment from site for modification to be made elsewhere, due to the tools and/or expertise required, or to provide entirely different equipment altogether.

### SUMMARY OF THE INVENTION

It is amongst the aims and objects of the invention to provide apparatus, systems and methods for use in the removal of ferrous or magnetically attractable particles from a fluid which obviate or mitigate one or more drawbacks or disadvantages of known apparatus, systems and methods.

It is amongst the aims and objects of the invention to provide apparatus, systems and methods for use in the removal of ferrous or magnetically attractable particles from a fluid which are an alternative to and/or improvement on known apparatus, systems and methods.

An object of the invention is to provide an apparatus which increases the flexibility of ferrous or magnetically attractable particle removal equipment.

Further objects and aims of the invention will become apparent from the following description.

According to a first aspect of the invention there is provided a modular frame for mounting at least one magnet apparatus in a fluid receptacle, the modular frame comprising:
first and second engagement members for engaging the frame with a wall of the fluid receptacle; and
at least one coupling member for coupling the at least one magnet apparatus to the frame such that the at least one magnet apparatus is mountable in the fluid receptacle to attract and remove ferrous or magnetically attractable particles from a fluid volume in the fluid receptacle;
wherein the first and second engagement members are respectively removably connected to the at least one coupling member.

The fluid receptacle may be any receptacle capable of holding flowing or stationary fluid.

The fluid receptacle may be a vessel, a tank, a fluid channel or a fluid ditch, a pipeline or a flowline.

The fluid receptacle may be configured to contain fluid contaminated with metal particles which may be ferrous or magnetically active.

The fluid receptacle may be configured to receive, hold and/or contain liquid or slurry which may be removed from a wellbore. The fluid may comprise drilling mud, water and/or other wellbore fluids. The magnetically active or ferrous particles may be drill swarf and/or steel and/or debris from a pipe, tubular, wellbore casing and/or other metallic wellbore component.

The first and second engagement members may comprise elongated support members, configured to extend vertically in the fluid receptacle and be removably securable to the wall of the fluid receptacle. The support members may comprise a plurality of connection points arranged over the direction of elongation, wherein the connection points are configured to enable the at least one coupling portion to be positioned at a selected vertical height in the fluid receptacle. Alternatively, or in addition, the plurality of connection points may enable the engagement members to be removably secured to the wall of the fluid receptacle at a selected vertical height in the fluid receptacle. This May facilitate placement of the modular frame in a wide range of different fluid receptacles and/or locations in a fluid receptacle, taking into account for example receptacle wall height, fluid depth, receptable base height, size and/or type and/or strength of magnet assemblies, flow regimes etc.

The modular frame may comprise horizontal securing members configured to rest on an upward facing surface of the fluid receptacle, for example a base surface of the fluid receptable. The first and second engagement members may comprise horizontal securing members configured to rest on an upward facing surface or edge of the wall.

The at least one coupling member may be a part of a coupling assembly which is configured to span a part of the fluid receptacle, for example from a first wall portion to a second wall portion. The coupling assembly may be formed from multiple coupling members, at least some of which are configured to couple a respective magnet apparatus to the frame such that the magnet apparatus is suspended in the fluid receptacle. Preferably, each of the multiple coupling members is configured to couple a respective magnet apparatus to the frame such that the magnet apparatus is suspended in the fluid receptacle. The multiple coupling members may be identical to one another.

In this embodiment, the modular frame can be assembled to a required size from a kit of standardised coupling members to form a coupling assembly. This may facilitate placement of the modular frame in a wide range of different fluid receptacles and/or locations in a fluid receptacle, taking into account for example receptacle width, size and/or type and/or strength of magnet assemblies, flow regimes, fluid viscosity and/or solid content, swarf type and/or density etc.

The at least one coupling member comprises an aperture, projection, groove or recess configured to engage with a corresponding aperture, projection, groove or recess on the magnet apparatus. The at least one coupling member may comprise an aperture configured to receive the magnet apparatus.

Each of the coupling members may be of the same shape, size and configuration or some or all of the coupling members may differ in shape, size and configuration.

The first and/or second engagement member may engage a wall of the fluid receptacle by simply abutting or resting on the wall of the fluid receptacle. Alternatively, or in addition, the first and/or second engaging member may engage a wall of the fluid receptacle by being positively secured to the wall for example by screwing, nailing, clamping, adhering or otherwise securing the member to the wall.

The at least one coupling member may comprise a connection means configured to be connected to the magnet apparatus which comprises (but is not limited to): nuts and bolts, screws, clamps, threaded connectors and/or push-fit connectors.

The first and second engagement members, and the coupling member may be removably connected to each other by any removable connection means, including (but not limited to): nuts and bolts, screws, corresponding slots and grooves, clamps, threaded connectors and/or push-fit connectors.

The first and second engagement members, and the coupling member may be formed from the same materials. Alternatively, the first and second engagement members, and the coupling member may be formed from different materials, or a combination of materials. At least one of the first and second engagement members, and the coupling member may be formed, at least in part, from steel which may in particular be stainless steel grade 316 or mild steel.

According to a second aspect of the invention there is provided a kit of parts, which when assembled together, forms the modular frame according to the first aspect of the invention.

Embodiments of the second aspect of the invention may include one or more features of the first aspect of the invention or its embodiments, or vice versa.

According to a third aspect of the invention, there is provided a ferrous particle removal system comprising:
a fluid receptacle for containing fluid contaminated with ferrous or magnetically attractable particles;
a modular frame according to the first or second aspect of the invention; and at least one magnet apparatus;
wherein the modular frame engages with a wall of the fluid receptacle, and wherein the at least one magnet apparatus is coupled to the frame such that it is mounted in the fluid receptacle to attract and remove ferrous or magnetically attractable particles from a fluid volume in the fluid receptacle.

The system may comprise an additional frame or frames, which may be an additional frame or frames according to the first aspect of the invention. The additional frame or frames may also engage the fluid receptacle and may also mount one or more ferrous particle removal apparatus in the fluid receptacle.

Embodiments of the third aspect of the invention may include one or more features of the first and second aspects of the invention or their embodiments, or vice versa.

According to a fourth aspect of the invention there is provided a method of removing ferrous particles from a fluid contaminated with ferrous or magnetically attractable particles in a system according to the third aspect of the invention;

the method comprising:
attracting ferrous or magnetically attractable particles in the fluid to the at least one ferrous particle removal apparatus; and removing the ferrous or magnetically attractable particles from the fluid.

The method may comprise removing the at least one magnet apparatus and attached ferrous or magnetically attractable particles from the fluid receptacle, thereby separating the ferrous or magnetically attractable particles from the fluid.

The method may comprise releasing the ferrous or magnetically attractable particles from the at least one magnet apparatus at a discharge location.

Embodiments of the fourth aspect of the invention may include one or more features of the first to third aspects of the invention or their embodiments, or vice versa.

According to a fifth aspect of the invention there is provided a method of installing a modular frame for mounting at least one magnet apparatus in a fluid receptacle, the method comprising:
assembling a modular frame from a kit of parts according to the second aspect of the invention by removably connecting the first and second engagement members to the at least one coupling portion; and
locating the assembled frame in or on the fluid receptacle by engaging a wall of the fluid receptacle such that the at least one magnet assembly is mountable in the fluid receptacle to attract and remove ferrous or magnetically attractable particles from a fluid volume in the fluid receptacle.

The method may comprise coupling the at least one magnet apparatus to the frame such that it is mounted in the fluid receptacle to attract and remove ferrous or magnetically attractable particles from a fluid volume in the fluid receptacle.

Embodiments of the fifth aspect of the invention may include one or more features of the first to fourth aspects of the invention or their embodiments, or vice versa.

There may be provided a kit of parts for a frame to mount one or more ferrous particle removal apparatus to a fluid receptacle, the kit of parts comprising:
a first member configured to engage to a wall of the fluid receptacle;
a second member configured to engage a wall of the fluid receptacle; and at least one member configured to be coupled to a ferrous particle removal apparatus to support all or part of the ferrous particle removal apparatus in the fluid receptacle;
wherein the first member, the second member and/or the at least one member are configured to be removably connected to each other.

There may be provided a fluid receptacle for containing fluid contaminated with ferrous or magnetically attractable particles;

a modular frame for mounting one or more ferrous or magnetically attractable particle removal apparatus in the fluid receptacle; and at least one ferrous particle removal apparatus;

wherein the frame engages the fluid receptacle, and wherein the at least one ferrous particle removal apparatus is coupled to the frame such that the at least one ferrous particle removal apparatus is mounted in the fluid receptacle to remove ferrous or magnetically attractable particles from a fluid contained in the fluid receptacle.

There may be provided a method of removing ferrous particles from a fluid contaminated with ferrous or magnetically attractable particles, the method comprising:
providing a system comprising:
a fluid receptacle containing fluid contaminated with ferrous or magnetically attractable particles;
a modular frame for mounting one or more ferrous or magnetically attractable particle removal apparatus in the fluid receptacle, engaging the fluid receptacle; and
at least one ferrous particle removal apparatus coupled to the frame, such that the at least one ferrous particle removal apparatus at least partially extends into the fluid contaminated with ferrous or magnetically attractable particles;
attracting ferrous or magnetically attractable particles contained in the fluid to the at least one ferrous particle removal apparatus; and removing the ferrous or magnetically attractable particles from the fluid.

The step of removing the ferrous or magnetically attractable particles from the fluid May comprise flowing the fluid away from the at least one ferrous particle removal apparatus, following attraction of the ferrous or magnetically attractable particles to the at least one ferrous particle removal apparatus, thereby separating the ferrous or magnetically attractable particles from the fluid.

The step of removing the ferrous or magnetically attractable particles from the fluid may comprise removing the at least one ferrous particle removal apparatus from the fluid receptacle following attraction of the ferrous or magnetically attractable particles to the at least one ferrous particle removal apparatus, thereby separating the ferrous or magnetically attractable particles from the fluid.

There may be provided a method of mounting one or more ferrous or magnetically attractable particle removal apparatus in a fluid receptacle, the method comprising:
a) providing a modular frame for mounting one or more ferrous or magnetically attractable particle removal apparatus in the fluid receptacle;
b) locating the frame in or on the fluid receptacle by engaging a wall of the fluid receptacle with a first member of the frame and by engaging a wall of the fluid receptacle with a second member of the frame; and
c) coupling a ferrous or magnetically attractable particle removal apparatus to at least one member of the frame.

The frame may be a frame according to the first aspect of the invention.

The method may comprise forming the frame from a kit of parts.

The method may comprise forming the frame according to the first aspect of the invention from a kit of parts, which may be a kit of parts according to the second aspect of the invention.

According to another aspect of the invention there is provided a method of mounting one or more ferrous or magnetically attractable particle removal apparatus in a fluid receptacle, the method comprising:
a) providing a kit of parts for a frame;
b) locating the kit of parts in or on the fluid receptacle by engaging a wall of the fluid receptacle with a first member of the kit of parts and by engaging a wall of the fluid receptacle with a second member of the kit of parts;
c) forming a frame from the kit of parts by removably connecting the first member, the second member and/or at least one member configured to be coupled to a ferrous particle removal apparatus to support all or part of the ferrous particle removal apparatus in the fluid receptacle to each other; and
d) coupling a ferrous or magnetically attractable particle removal apparatus to the at least one member of the frame.

The kit of parts may be a kit of parts according to the second aspect of the invention.

Steps b), c) and d) may be performed in any order. Any or all of steps b), c) and d) may be performed simultaneously.

Embodiments of this other aspect of the invention may include one or more features of any previous aspect of the invention or its embodiments, or vice versa.

According to another aspect of the invention there is provided a method of installing a frame for mounting one or more ferrous or magnetically attractable particle removal apparatus in a fluid receptacle, the method comprising:
a) providing a modular frame for mounting one or more ferrous or magnetically attractable particle removal apparatus in the fluid receptacle; and
b) locating the frame in or on the fluid receptacle by engaging a wall of the fluid receptacle with a first member of the frame and by engaging a wall of the fluid receptacle with a second member of the frame.

The frame may be a frame according to the first aspect of the invention.

Embodiments of this other aspect of the invention may include one or more features of any previous aspect of the invention or its embodiments, or vice versa.

According to this other aspect of the invention there is provided a method of installing a frame for mounting one or more ferrous or magnetically attractable particle removal apparatus in a fluid receptacle, the method comprising:
a) providing a kit of parts for a frame;
b) locating the kit of parts in or on the fluid receptacle by engaging a wall of the fluid receptacle with a first member of the kit of parts and by engaging a wall of the fluid receptacle with a second member of the kit of parts; and
c) forming a frame from the kit of parts by removably connecting the first member, the second member and/or at least one member configured to be coupled to a ferrous particle removal apparatus to support all or part of the ferrous particle removal apparatus in the fluid receptacle to each other.

The kit of parts may be a kit of parts according to the second aspect of the invention.

Steps b) and c) may be performed in any order. Steps b) and c) may be performed simultaneously.

Embodiments of this other aspect of the invention may include one or more features of any previous aspect of the invention or its embodiments, or vice versa.

According to another aspect of the invention there is provided a method of re-configuring a frame for mounting one or more ferrous or magnetically attractable particle removal apparatus in a fluid receptacle, the method comprising:
starting with a frame according to the first aspect of the invention, disconnecting the first member, the second member and/or the at least one member from each other;
forming a new frame using at least one of the first member, the second member and/or the at least one member.

The method may comprise removing the frame from a fluid receptacle.

The method may comprise forming the new frame by re-arranging the first member, the second member and/or the at least one member and removably connecting the first member, the second member and/or the at least one member together in a different configuration.

The method may comprise removing and/or replacing one or more of the first member, the second member and/or the at least one member to form the new frame.

The method may comprise forming the new frame using additional members, not included in the starting frame.

Embodiments of this other aspect of the invention may include one or more features of any previous aspect of the invention or its embodiments, or vice versa.

### BRIEF DESCRIPTION OF THE DRAWINGS

There will now be described, by way of example only, various embodiments of the invention with reference to the drawings, of which:

FIG. 1 is a partially cut-out elevation of a partially assembled ferrous particle removal system according to an embodiment of the invention;

FIGS. 2A and 2B are side and front views, respectively, of a supporting member of a frame according to an embodiment of the invention;

FIGS. 3A and 3B are side and front views, respectively, of a securing member of a frame according to an embodiment of the invention;

FIGS. 4A, 4B and 4C are front, side and plan views, respectively, of a rod attachment member of a frame according to an embodiment of the invention;

FIGS. 5A and 5B are side views of a magnetic rod device in first and second conditions;

FIG. 6 is a perspective view of a clamp for a magnetic rod device; and

FIGS. 7 to 9 are partially cut-out front elevations of partially assembled ferrous particle removal systems according to alternative embodiments of the invention.

### DETAILED DESCRIPTION OF PREFERRED EMBODIMENTS

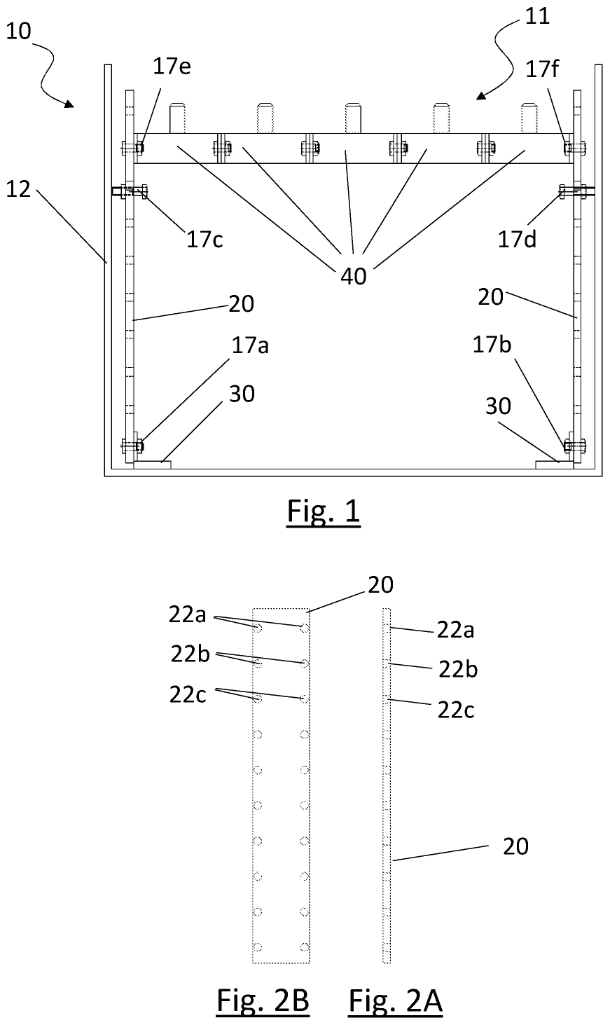

Referring firstly to FIG. 1 there is shown, generally at 10, a partially assembled ferrous particle removal system according to an embodiment of the invention. The system comprises a fluid channel 12 (shown partially cut-away for clarity) and a modular frame 11 for supporting a magnet apparatus (alternatively referred to as ferrous or magnetically attractable particle removal apparatus) in the form of elongated magnetic rod devices (not shown) such that, in use, they extend into contaminated fluid within the channel 12 (not shown) to separate ferrous or magnetically attractable particles (swarf) from the fluid.

The modular frame 12 is formed from numerous interconnected members, including first and second wall engagement members in the form of supporting members 20, two securing members 30, and five coupling members in the form of rod attachment members 40, all of which will be described in more detail throughout the following description. The securing members 30 sit on the base of the channel 12 to hold the elongated supporting members 20 in a vertical orientation within the channel 12. The securing members 30 are connected to the supporting members 20 by bolts 17a and 17b. Additional bolts, 17c and 17d, are provided around the top end region of the supporting members 20 to connect them directly to the walls of the channel 12. The supporting members 20 are connected to a coupling assembly formed from five interconnected rod attachment members 40 across the mouth of the channel, the outermost rod attachment members 40 being connected to the supporting members 20 by bolts 17e and 17f and the rod attachment members 40 being similarly connected to one another by bolts.

The bolts, 17a, 17b, 17c, 17d, 17e and 17f extend through pre-formed holes in the supporting members 20 and respective pre-formed holes in the securing members 30 and rod attachment members 40. Likewise, the bolts which connect the five rod attachment members 40 together extend through pre-formed holes in the rod attachment members.

In use, the fluid channel 12 receives fluid flowing from a wellbore operation which contains ferrous swarf. The elongated magnetic rod devices (not shown) are suspended from the frame such that they extend into the wellbore fluid, producing magnetic fields which magnetically attract the swarf to the rod devices and remove it from the fluid.

FIGS. 2A and 2B show one of the supporting members 20 used in the FIG. 1 system in more detail. The supporting member 20 is a rectangular plate comprising multiple pairs of pre-formed holes 22a, 22b, 22c and so on. The holes allow bolts to be coupled to the supporting member 20 to attach it to other frame components, or to a fluid channel, ditch or vessel.

As the supporting member 20 comprises multiple pairs of connection points in the form of pre-formed holes 20a, 20b and 20c, the position of other various frame members-notably the height of the rod attachment members 40 in the channel 12 in the FIG. 1 system—can be selected.

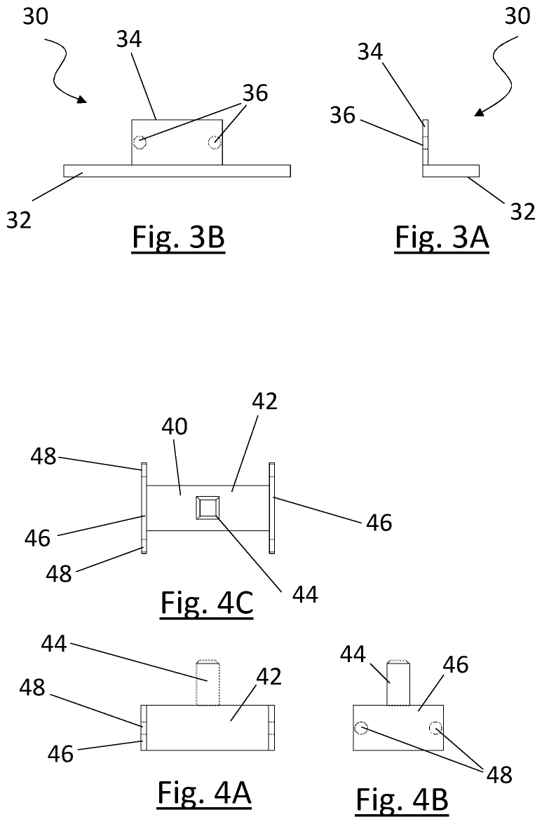

FIGS. 3A and 3B show one of the securing members 30 used in the FIG. 1 system in more detail. The securing member comprises first 32 and second 34 rectangular plates, arranged perpendicularly to one another. The second plate 34 is narrower than the first plate 32, having a width equal to the width of the supporting member 20, and comprises a pair of pre-formed holes 36 which allow bolts to be passed through the securing member to attach the securing member 30 to other frame components-such as the supporting members 20, as in FIG. 1—or to the walls of a fluid channel, ditch or vessel. In FIG. 1, the first plate 32 sits upon the inner surface of the bottom wall of the channel; however, in an alternative arrangement it could be firmly affixed. In some embodiments of the invention, securing members may be permanently connected to a vessel, channel or ditch wall and left there, even when other frame components have been removed or relocated.

FIGS. 4A, 4B and 4C show one of the rod attachment members 40 used in the FIG. 1 system in more detail. The rod attachment member 40 comprises a base body portion 42, from which a rod receiving peg 44 protrudes. The peg 44 is configured to be attached to a magnetic rod device, to hold it on the frame. In alternative configurations, the peg may be omitted and replaced by an alternative means for attaching a ferrous particle removal tool to the frame (for example, by providing a clip or a clamp on the rod attachment member 40) Two rectangular end plates 46 are located on opposite surfaces of the base body portion 42, each comprising a pair of holes 48. The width of the plates 46 is equal to the width of the supporting member 20, and the holes 48 allow bolts to be passed through them to attach the rod attachment member 40 to other frame components-such as the supporting members 20, and additional rod attachment members 40 as in FIG. 1—or to the walls of a fluid channel, ditch or vessel.

It will be appreciated that the shape, dimensions and overall configuration of the supporting members, the securing members, and the rod attachment members can differ from those which are shown in FIGS. 1 to 4C. Each member can also be provided with more or less bolt holes, or none at all. Alternative coupling or fixing means, or a combination of coupling or fixing means, can be used for each of the frame members. The various frame members can also be used in different ways to that described with reference to the above Figures, in different combinations, and in different orientations.

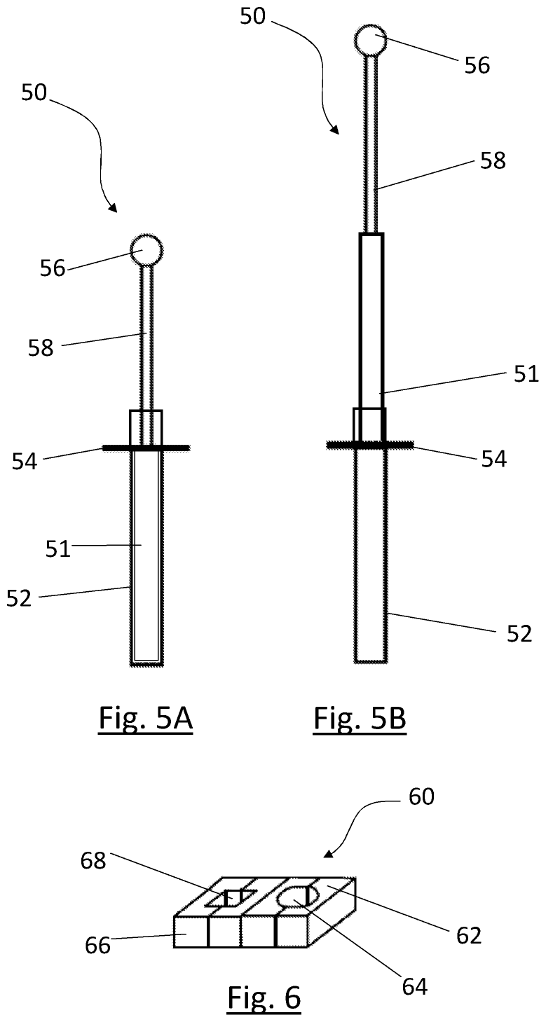

FIGS. 5A and 5B show an example of a magnetic rod device, generally at 50, which can be supported by the frame according to embodiments of the invention. The device 50 comprises a magnet portion 51 which is slidably mounted within casing 52 (which is shown as being transparent, for clarity). The device 50 also has a removal means in the form of a plate 54 on the outer surface of the casing 52. The device 50 has a first condition and a second condition. In its first condition, as shown in FIG. 5A, the magnet portion 51 of the device 50 is positioned substantially below the removal plate 54 and in its second condition, as shown in FIG. 5B, it is positioned substantially above the removal plate 54. The casing 52 of the magnetic rod devices is configured to extend into a contaminated fluid such that when the magnetic rod device 50 is in its first condition, the magnet portion 51 also extends into the fluid, inside of the casing 54, to attract ferrous or magnetically attractable particles to the outer surface of the casing and separate them from the fluid. The device can be cleaned by moving it into its second condition. When being moved into this condition, ferrous or magnetically attractable particles on the outer surface of the casing are moved in the same direction as the magnet portion 51, until the plate 54 stops them from moving any further. By moving the magnet portion 51 above the plate 54, its magnetic field no longer holds the ferrous or magnetically attractable particles in place, and they are able to drop off of the casing 52. The device 50 is moved between its first and second conditions by a handle 56 which is connected to the magnet portion 51 by a rod 58.

It will be appreciated that frames according to embodiments of the invention can be used to support different magnet apparatus or ferrous particle removal tools, other than the type which is shown in FIGS. 5A and 5B.

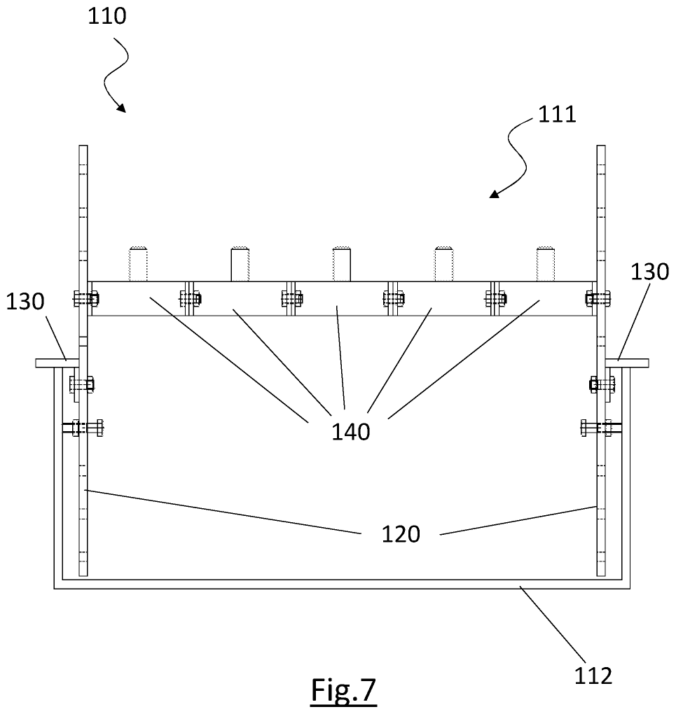

FIG. 6 shows an example of a clamp 60 which can be used to mount a magnetic rod device on the frame shown in FIG. 1. The clamp comprises a first clamp section 62 formed from two halves and defining a circular aperture and a second clamp section 66 similarly formed from two halves and defining a square aperture 68. The first clamp section is configured to be firmly clamped around the casing of a magnetic rod device. The square aperture of the second clamp section 66 is configured to slot over or clamp around a peg 44 of a rod attachment member 40, to mount the magnetic rod device on the frame. FIGS. 7 to 9 show alternative partially assembled ferrous particle removal systems according to embodiments of the invention, employing alternative frame configurations.

The system 110 of FIG. 7 is similar to the system 10 of FIG. 1, and will be understood from FIG. 1 and the accompanying description, with like features labelled with like reference numerals incremented by 100. The system 110 differs from the system 10 in that the channel 112 is shallower than the channel 12. Instead of being positioned at the base of the supporting members 120, the securing members 130 are rotated with respect to the securing members 30 of FIG. 1 and are bolted to the supporting members 120 at around their mid-way points. The securing members 130 rest on top of the channel 112 walls to elevate the frame in the channel 112.

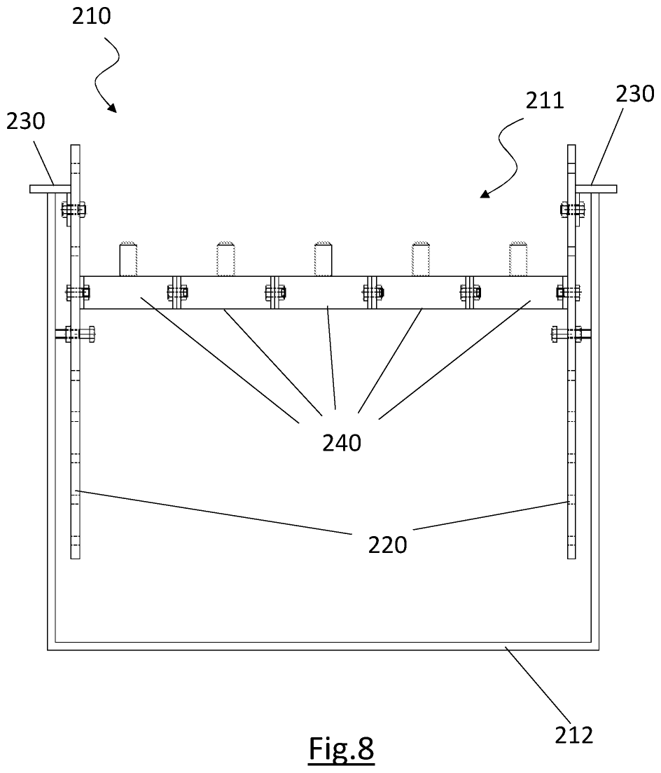

The system 210 of FIG. 8 is similar to the system 10 of FIG. 1, and will be understood from FIG. 1 and the accompanying description, with like features labelled with like reference numerals incremented by 200. The system 210 is very similar to the system 110 of FIG. 7; however, differs in that the channel 212 is deeper than the channel 112 of FIG. 7. The securing members 230 are bolted to the supporting members 220 close to their top ends, such that a greater portion of the supporting members 220 extend into the volume of the channel 212.

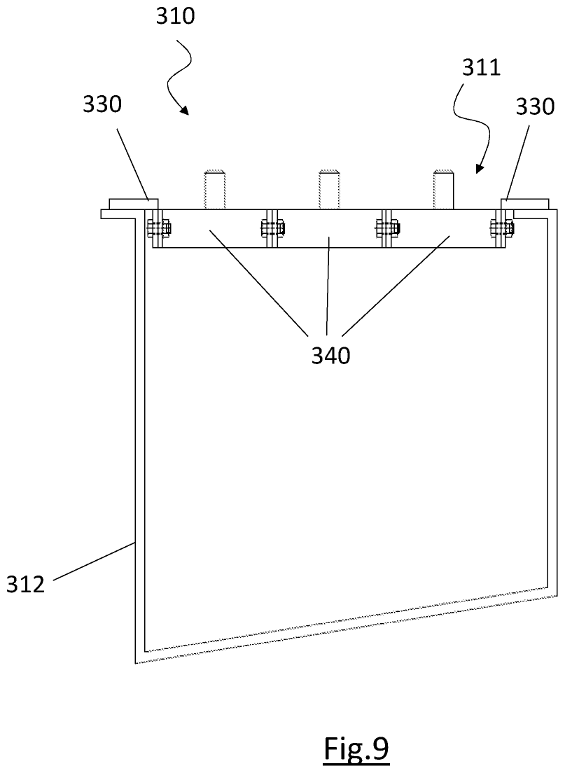

The system 310 of FIG. 9 is similar to the system 10 of FIG. 1, and will be understood from FIG. 1 and the accompanying description, with like features labelled with like reference numerals incremented by 300. The system 310 differs from the system 10 in that the channel 312 has an inclined bottom surface. In addition, the frame 311 does not include engagement members in the form of vertically oriented elongated supporting members. Instead, it is formed by first and second engagement members in the form of securing members 330, which rest on top of the channel 312 walls to elevate the frame in the channel 312 and which, between them, support three rod attachment members 340.

A frame according to embodiments of the present invention can be modified to suit the vessel, channel or ditch which it is intended to function with. The fluid channels of FIGS. 1, 7, 8 and 9 all differ from one another in some way, and the modularity of the frame makes it possible to configure it in ways which are appropriate for each different fluid channel. This is advantageous, because instead of designing, ordering and manufacturing a bespoke frame to suit a specific fluid vessel, channel or ditch-which is expensive, difficult to manufacture, labour intensive, difficult to transport and unlikely to be able to be re-used in other fluid vessels, channels or ditches-a suitable frame can be constructed using a number of smaller, standardised components. This reduces cost, simplifies manufacturing, and eases transport and storage logistics, as individual frame members are substantially smaller in size and weight than an entire frame. The modular frame solution is also more flexible; it can be assembled from a kit of components to suit a specific fluid receptacle, disassembled if or when it is no longer needed and re-used in a different location or application, in a different arrangement or configuration.

By keeping an inventory of frame members on-site, frames for supporting ferrous particle removal devices can be constructed to suit fluid vessels, channels and ditches as required. Storage of the frame components requires less space than storing bespoke, fully formed frames, which are also less flexible in their use.

The modular nature of the frame also allows it to be modified to increase or reduce the number of ferrous particle removal tools which it is able to hold, or to support a different kind of ferrous particle removal tool altogether. In this way, should the facility forecast a change in swarf production (an increase, for example) or fluid/slurry properties, the frame can be appropriately adjusted to enable the use of more, or stronger, ferrous particle removal tools. In other words, the frame can be modified to increase the capability of a ferrous particle removal system without having to supply an entirely new frame or an entirely new system or tool.

The invention provides a modular frame for mounting at least one magnet apparatus in a fluid receptacle, a kit of parts for forming the modular frame, a system for removing ferrous particles from a fluid receptacle, and methods of use. The modular frame comprises first and second engagement members for engaging the frame with a wall of the fluid receptacle, and at least one coupling member for coupling the magnet apparatus to the frame. The magnet apparatus is mountable in the fluid receptacle to attract and remove ferrous or magnetically attractable particles from a fluid volume in the fluid receptacle. The first and second engagement members are respectively removably connected to the at least one coupling member. The modular frame may be assembled from a kit of standardised components to fit a particular fluid receptacle, and may be disassembled or reconfigured according to requirements.

The invention may provide a frame for mounting one or more ferrous or magnetically attractable particle removal apparatus in a fluid receptacle. The frame comprises a first member configured to engage a wall of the fluid receptacle, a second member configured to engage a wall of the fluid receptacle and at least one member configured to be coupled to a ferrous particle removal apparatus to support all or part of the ferrous particle removal apparatus in the fluid receptacle. The first member, the second member and/or the at least one member are removably connected to each other. The invention also provides a system for removing ferrous or magnetically attractable particles from a fluid, comprising a frame and a kit of parts for forming a frame.

Various modifications may be made within the scope of the invention as herein intended, and embodiments of the invention may include combinations of features other than those expressly described herein.

1. A modular frame for mounting at least one magnet apparatus in a fluid receptacle, the modular frame comprising:
first and second engagement members for engaging the frame with a wall of the fluid receptacle; and
multiple coupling members removably connected to each other, each coupling member being configured to couple a magnet apparatus to the frame such that the magnet apparatus is mountable in the fluid receptacle to attract and remove ferrous or magnetically attractable particles from a fluid volume in the fluid receptacle:
wherein each of the first and second engagement members are respectively removably connected to at least one coupling member.

2. The modular frame according to claim 1, wherein the fluid receptacle is a vessel, tank, fluid channel, fluid ditch, pipeline or flowline configured to receive, hold and/or contain liquid or slurry which has been removed from a wellbore.

3. The modular frame according to claim 1, wherein the first and second engagement members are configured to engage the frame with the wall of the fluid receptacle by removably securing them to the wall.

4. The modular frame according to claim 1, wherein the first and second engagement members comprise elongated support members, configured to extend vertically in the fluid receptacle and be removably securable to the wall of the fluid receptacle.

5. The modular frame according to claim 4, wherein the support members comprise a plurality of connection points arranged over the direction of elongation, wherein the connection points are configured to enable at least one coupling member to be positioned at a selected vertical height in the fluid receptacle, and/or to enable the engagement members to be removably secured to the wall of the fluid receptacle at a selected vertical height in the fluid receptacle.

6. The modular frame according to claim 4, further comprising horizontal securing members configured to rest on an upward facing surface of the fluid receptacle.

7. The modular frame according to claim 6, wherein the first and second engagement members comprise horizontal securing members configured to rest on an upward facing surface or edge of the wall.

8. The modular frame according to claim 1, wherein the multiple coupling members form a coupling assembly which is configured to span a part of the fluid receptacle.

9. (canceled)

10. The modular frame according to claim 1, wherein the multiple coupling members are identical to one another.

11. The modular frame according to claim 1, wherein the multiple coupling members comprise an aperture, projection, groove or recess configured to engage with a corresponding aperture, projection, groove or recess on the at least one magnet apparatus.

12. The modular frame according to claim 1, wherein the multiple coupling members comprise an aperture configured to receive the at least one magnet apparatus.

13. (canceled)

14. A ferrous particle removal system comprising:
a fluid receptacle for containing fluid contaminated with ferrous or magnetically attractable particles:
a modular frame as claimed in claim 1; and
at least one magnet apparatus:
wherein the modular frame engages with a wall of the fluid receptacle, and wherein the at least one magnet apparatus is coupled to the frame such that it is mounted in the fluid receptacle to attract and remove ferrous or magnetically attractable particles from a fluid volume in the fluid receptacle.

15. The system as according to claim 14, comprising one or more additional modular frames configured to mount additional magnet apparatus in the fluid receptacle.

16. A method of removing ferrous particles from a fluid contaminated with ferrous or magnetically attractable particles in a system according to claim 14;
the method comprising:
attracting ferrous or magnetically attractable particles in the fluid to the at least one ferrous particle removal apparatus; and
removing the ferrous or magnetically attractable particles from the fluid.

17. The method according to claim 16, wherein removing the ferrous or magnetically attractable particles from the fluid comprises removing the at least one magnet apparatus and attached ferrous or magnetically attractable particles from the fluid receptacle, thereby separating the ferrous or magnetically attractable particles from the fluid.

18. The method according to claim 17, comprising releasing the ferrous or magnetically attractable particles from the at least one magnet apparatus at a discharge location.

19. A method of installing a modular frame for mounting at least one magnet apparatus in a fluid receptacle, the method comprising:
assembling a modular frame from a kit of parts according to claim 13 by removably connecting the first and second engagement members to at least one of the multiple coupling members; and
locating the assembled frame in or on the fluid receptacle by engaging a wall of the fluid receptacle such that the at least one magnet assembly is mountable in the fluid receptacle to attract and remove ferrous or magnetically attractable particles from a fluid volume in the fluid receptacle.

20. The method according to claim 19, further comprising coupling the at least one magnet apparatus to the frame such that it is mounted in the fluid receptacle to attract and remove ferrous or magnetically attractable particles from a fluid volume in the fluid receptacle.
